(19) United States
(12) Patent Application Publication
(10) Pub. No.: US 2008/0237532 A1
(43) Pub. Date: Oct. 2, 2008

(54) POWDER MAGNETIC CORE

(75) Inventors: Hideharu Moro, Tokyo (JP); Sadaki Satoh, Tokyo (JP); Tsuneo Suzuki, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Tokyo (JP)

(21) Appl. No.: 12/054,119

(22) Filed: Mar. 24, 2008

(30) Foreign Application Priority Data
Mar. 26, 2007 (JP) P2007-079673

(51) Int. Cl. H01F 1/01

(52) U.S. Cl. 252/62.51 C; 252/62.51 R

(57) ABSTRACT

The object of the present invention is to provide a powder magnetic core having higher dielectric withstand voltage properties than conventional powder magnetic cores, while keeping magnetic permeability at a similar or higher level than in conventional powder magnetic cores. In order to achieve the above object, the present invention provides a powder magnetic core containing a magnetic material powder and a binder resin, wherein the apparent density D of the powder magnetic core, the abundance E of the magnetic material powder in the surface of the powder magnetic core, the mass ratio Rm of the magnetic material powder relative to the powder magnetic core, and the true density Dm of the magnetic material powder satisfy the condition represented by expression (1)

Vc>E−a×(D·Rm/Dm)^{2/3}×100 (1)

(in expression (1), the units of D and Dm are g/cm³, the unit of E is %, and Rm is unitless. Vc denotes a predefined threshold value, and a denotes a predefined coefficient).

### BACKGROUND OF THE INVENTION

1. Field of the Invention

The present invention relates to a powder magnetic core.

2. Related Background Art

Powder magnetic cores have been used as a kind of magnetic core that is found in, for instance, inductance elements or the like. Such powder magnetic cores are ordinarily manufactured by molding, into a predefined shape, a mixture comprising a magnetic material and an insulating binder resin, followed by curing of the binder resin. These powder magnetic cores must possess characteristics such as high saturation magnetization and/or magnetic permeability, and low magnetic core loss.

The demands placed on such characteristics have become more stringent in recent years, in particular, as a result of the miniaturization of inductance elements and the like. For instance, Japanese Unexamined Patent Application Laid-open Nos. H11-54314, H11-204359 and 2002-217014 disclose various approaches for achieving high magnetic permeability. In the above documents, high magnetic permeability is achieved by increasing the packing ratio of magnetic material powder in a powder magnetic core.

### SUMMARY OF THE INVENTION

In addition to the above various characteristics, the powder magnetic core must exhibit also high dielectric withstand voltage properties. However, increasing the packing ratio of the magnetic material powder with a view to increasing the magnetic permeability of a conventional powder magnetic core is problematic in that dielectric withstand voltage properties become impaired as a result.

In the light of the above, it is an object of the present invention to provide a powder magnetic core having higher dielectric withstand voltage properties than conventional powder magnetic cores, while keeping magnetic permeability at a similar or higher level than in conventional powder magnetic cores.

In order to achieve the above object, the present invention provides a powder magnetic core comprising a magnetic material powder and a binder resin, wherein the apparent density D of the powder magnetic core, the abundance E of the magnetic material powder in the surface of the powder magnetic core, the mass ratio Rm of the magnetic material powder relative to the powder magnetic core, and the true density Dm of the magnetic material powder satisfy the condition represented by expression (1)

Vc>E−a×(D·Rm/Dm)^{2/3}×100 (1)

(in expression (1), the units of D and Dm are g/cm³, the unit of E is %, and Rm is unitless. Vc denotes a predefined threshold value, and a denotes a predefined coefficient).

The apparent density D of the powder magnetic core is the value obtained by dividing the mass (units: g) of the powder magnetic core by the apparent volume (units: cm³) of the powder magnetic core. The apparent volume is determined by an Archimedean method. The abundance E of magnetic material powder in the surface of the powder magnetic core is obtained by analyzing photographed images of the surfaces of powder magnetic cores, and is expressed as a percentage of the area occupied in the image by magnetic material powder relative to the surface area of the powder magnetic core. The mass ratio Rm of magnetic material powder relative to the powder magnetic core is a value determined based on the mass ratios of magnetic material powder and binder resin during the manufacture of the powder magnetic core.

The above-described magnetic permeability becomes higher when the apparent density D of the powder magnetic core increases with an increasing proportion (packing ratio) of the magnetic material powder in the powder magnetic core, because distances between magnetic material powder portions in the powder magnetic core become shorter thereby. Shorter distances between magnetic material powder portions, however, entail as a matter of course lessened dielectric withstand voltage properties in the powder magnetic core. It is therefore extremely difficult to enhance the dielectric withstand voltage properties of a powder magnetic core while preserving high magnetic permeability.

As a result of painstaking research on conventional powder magnetic cores, however, the inventors found that there is still room for improvement as regards dielectric withstand voltage properties of powder magnetic cores, as described below. Specifically, conventional powder magnetic cores are manufactured through a molding process in which a mold is invariably used. The inventors found that, upon removal of a molded product of the powder magnetic core from the mold, after the molding process, there occurs abrasion between the inner walls of the mold and the outer surface of the molded product. This is caused by the so-called springback phenomenon, in which the volume of the powder magnetic core tends to expand slightly on account of the resilience of the molded product.

Abrasion between the inner wall of the mold and the outer surface of the molded product causes peeling of the binder resin present on the outer surface of the molded product, and gives rise also to surface spread of the magnetic material powder. As a result, the distance between magnetic material powder portions on the surface of the powder magnetic core becomes smaller. This favors the flow of current on the surface of the powder magnetic core, which precludes, as a result, achieving sufficiently high dielectric withstand voltage properties in the powder magnetic core.

The inventors conjectured that preventing abrasion between the inner wall of the mold and the outer surface of the molded product as much as possible should allow enhancing the dielectric withstand voltage properties of the powder magnetic core while preserving high magnetic permeability in the latter. As a result of diligent research on this approach, the inventors perfected the present invention upon confirming that abrasion between the inner wall of the mold and the outer surface of the molded product can be made sufficiently smaller than in conventional technology, and that doing so allows enhancing dielectric withstand voltage properties. That is, the essential feature of the present invention consists in curbing abrasion between the inner wall of a mold and the outer surface of a molded product upon removal of a molded product of a powder magnetic core from the mold. Thus far, no inventions have realized, on the basis of the above approach, enhanced dielectric withstand voltage properties in a powder magnetic core while preserving high magnetic permeability in the powder magnetic core.

The expression (D·Rm/Dm)^{2/3}×100 in the above expression (1) denotes the difference between a two-dimensional content ratio of magnetic material powder versus a theoretical value. Specifically, D·Rm/Dm denotes the volume ratio of magnetic material powder in the powder magnetic core as a whole. This value is raised to the power of 2/3 to yield a theoretical (unitless) two-dimensional abundance ratio. If there was absolutely no abrasion with the surface of the powder magnetic core, and there occurred no binder resin peeling or magnetic material powder spread, E−(D·Rm/Dm)^{2/3}×100 would yield a numerical value arbitrarily close to zero. When measurement error is taken into account, however, E−a×(D·Rm/Dm)^{2/3}×100 does not necessarily become zero. Also, the binder resin and/or the magnetic material powder may be distributed more or less unevenly on the surface of the powder magnetic core depending on the materials and composition ratios of the magnetic material powder and the binder resin, and depending on the molding method.

In the present invention, therefore, (D·Rm/Dm)^{2/3}×100 is multiplied in the first place by a coefficient a. The coefficient a, which reflects the unevenness of the distribution of binder resin and magnetic material powder on the surface of the magnetic core, is found to become smaller as the binder resin is distributed more unevenly, and larger as the magnetic material powder is distributed more unevenly. In the present invention, furthermore, E−a×(D·Rm/Dm)^{2/3}×100 is smaller than a predefined threshold value Vc. Ordinarily, the threshold value Vc is determined on the basis of the type and composition ratio of the magnetic material powder and binder resin in the powder magnetic core, and on the basis of the molding pressure during molding. The threshold value Vc is the value of E−a×(D·Rm/Dm)^{2/3}×100 during occurrence of abrasion between the inner wall of the mold and the outer surface of the molded product upon conventional manufacture of a powder magnetic core. The coefficient a and the threshold value Vc are derived experimentally.

For instance, the present invention provides a powder magnetic core being a powder magnetic core containing a magnetic material powder and a binder resin, wherein the apparent density D of the powder magnetic core and the abundance E of the magnetic material powder in the surface of the powder magnetic core satisfy the condition represented by expression (2)

39>E−12.5×(D^{2/3}) (2)

(in expression (2), the unit of D is g/cm³ and the unit of E is %). The apparent density D of the powder magnetic core and the abundance E of the magnetic material powder are the same as in expression (1).

The present invention was arrived at based on experiments carried out by the inventors. The left-hand term of expression (2) is the value of E−a×(D·Rm/Dm)^{2/3}×100 during occurrence of abrasion between the inner wall of the mold and the outer surface of the molded product upon conventional manufacture of a powder magnetic core.

In the present invention, preferably, the apparent density D of the powder magnetic core and the abundance E of the magnetic material powder in the surface of the powder magnetic core satisfy the condition represented by expression (2a) below

35≧E−12.5×(D^{2/3}) (2a)

(in expression (2a), the unit of D is g/cm³ and the unit of E is %). The apparent density D of the powder magnetic core and the abundance E of the magnetic material powder are the same as in expression (1). The left-hand term of expression (2a) is the value of E−a×(D·Rm/Dm)^{2/3}×100 as determined in examples according to the present invention.

In the present invention, more preferably, the magnetic material powder is a Fe—Si—Cr magnetic material powder, and the apparent density D of the powder magnetic core and the abundance E of the magnetic material powder on the surface of the powder magnetic core satisfy the condition represented by expression (3) below

−40>E−37.4×(D^{2/3}) (3)

(in expression (3), the unit of D is g/cm³ and the unit of E is %). The left-hand term of expression (3) is the value of E−a×(D·Rm/Dm)^{2/3}×100 during occurrence of abrasion between the inner wall of the mold and the outer surface of the molded product upon conventional manufacture of a powder magnetic core using a Fe—Si—Cr powder magnetic core, and is determined experimentally by the inventors.

In such a powder magnetic core, more preferably, the apparent density D of the powder magnetic core and the abundance E of the magnetic material powder in the surface of the powder magnetic core further satisfy the condition represented by expression (3a) below

−46≧E−37.4×(D^{2/3}) (3a)

(in expression (3a), the unit of D is g/cm³ and the unit of E is %). The apparent density D of the powder magnetic core and the abundance E of the magnetic material powder are the same as in expression (1). The left-hand term of expression (3a) is the value of E−a×(D·Rm/Dm)^{2/3}×100 as determined in examples according to the present invention.

In the present invention, preferably, the magnetic material powder is a Fe—Ni magnetic material powder, and the apparent density D of the powder magnetic core and the abundance E of the magnetic material powder on the surface of the powder magnetic core satisfy the condition represented by expression (4) below.

−39>E−34.4×(D^{2/3}) (4)

(in expression (4), the unit of D is g/cm³ and the unit of E is %). The left-hand term of expression (4) is the value of E−a×(D·Rm/Dm)^{2/3}×100 during occurrence of abrasion between the inner wall of the mold and the outer surface of the molded product upon conventional manufacture of a powder magnetic core using a Fe—Ni powder magnetic core, and is determined experimentally by the inventors.

In such a powder magnetic core, more preferably, the apparent density D of the powder magnetic core and the abundance E of the magnetic material powder in the surface of the powder magnetic core further satisfy the condition represented by expression (4a) below

−47≧E−34.4×(D^{2/3}) (4a)

(in expression (4a), the unit of D is g/cm³ and the unit of E is %). The apparent density D of the powder magnetic core and the abundance E of the magnetic material powder are the same as in expression (1). The left-hand term of expression (4a) is the value of E−a×(D·Rm/Dm)^{2/3}×100 as determined in examples according to the present invention.

The invention allows thus providing a powder magnetic core having higher dielectric withstand voltage properties than conventional powder magnetic cores, while keeping magnetic permeability at a similar or higher level than in conventional powder magnetic cores.

### BRIEF DESCRIPTION OF THE DRAWINGS

FIG. 1 is a schematic perspective-view diagram illustrating a powder magnetic core according to an embodiment of the present invention;

FIG. 2 is a schematic diagram illustrating a molding device used in a molding step according to an embodiment of the present invention;

FIG. 3 is a schematic diagram illustrating a molding device used in a molding step according to an embodiment of the present invention;

FIG. 4 is a schematic diagram illustrating a measurement method of dielectric withstand voltage properties of a powder magnetic core in examples of the present invention;

FIG. 5 are SEM photographs resulting from imaging the surface of powder magnetic cores according to an example and a comparative example of the present invention; and

FIG. 6 is graph in which there is plotted the relationship between values of apparent density D raised to the power of 2/3 and an abundance E.

### DESCRIPTION OF THE PREFERRED EMBODIMENTS

Preferred embodiments of the present invention are explained next in detail with reference to accompanying drawings. In the figures, identical elements are denoted with identical reference numerals. Repeated explanations of the reference numerals are omitted. Unless otherwise stated, the positional relationship among the elements in, for instance, the vertical and horizontal directions, are based on the positional relationship depicted in the drawings. The dimensional ratios in the drawings are not limited to the ratios depicted therein.

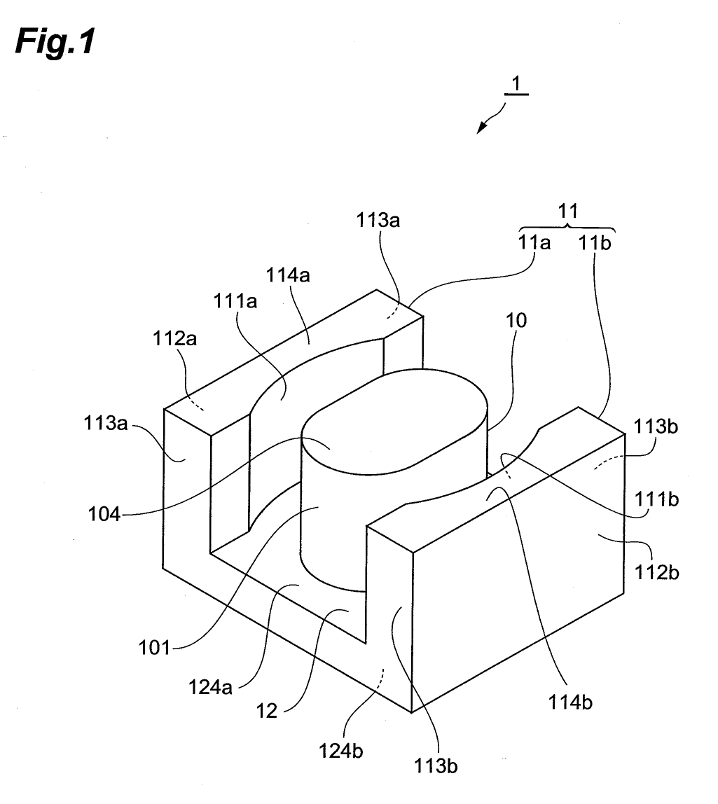

FIG. 1 is a perspective-view diagram illustrating schematically a powder magnetic core according to a preferred embodiment of the present invention. A powder magnetic core 1 comprises a core portion (central leg) 10 shaped as an elliptic cylinder, a pot portion (outer leg) 11 provided on the outer periphery of the core portion 10 with an air gap in between, and a joining portion 12 that joins the core portion 10 and the pot portion 11. An element such as an inductance element or the like is formed in the powder magnetic core 1 through coiling of a coil around the outer periphery of the core portion 10.

The core portion 10 is enclosed by an outer peripheral face 101 as a cylindrical surface, a planar top face 104 perpendicular to the outer peripheral face 101, and a bottom face (not shown) opposite the top face 104 and in contact with the joining portion 12.

The pot portion 11 comprises a set of wall-like members 11a,b. These wall-like members 11a, b are arranged facing each other with the core portion 10 standing centrally in between. The wall-like members 11a,b are enclosed by inner wall faces 111a,b facing the core portion 10; planar outer wall faces 112a,b that are the opposing planes of the inner wall faces 111a,b; a set of planar side wall faces 113a,b perpendicular to the outer wall faces 112a,b; planar top faces 114a,b perpendicular to the outer wall faces 112a,b and the side wall faces 113a,b; and a bottom face (not shown) opposite the top faces 114a, b and in contact with the joining portion 12. The inner wall faces 111a,b have concave cylindrical surfaces at the central portion of the inner wall faces 111a,b that face the core portion 10. The two edge portions of the inner wall faces 111a,b are planar. The top face 104 of the core portion 10 and the top faces 114a,b of the pot portion 11 are flush with each other.

The joining portion 12, which is shaped as a rectangular plate, is enclosed by main faces 124a,b and four side faces. The core portion 10 and the pot portion 11 are arranged on the joining portion 12 so that the bottom faces of the core portion 10 and the pot portion 11 are in contact with the main face 124a of the joining portion 12. The side faces of the joining portion 12 are flush with the outer wall faces 112a,b and the side wall faces 113a,b of the pot portion 11.

The powder magnetic core 1 is obtained through pressure forming, under predefined conditions, of a mixture comprising a magnetic material powder and a binder resin, further followed by a thermal treatment, as the case may require. After drying of a magnetic material powder having a binder resin added thereto, the dry magnetic material powder may be further mixed with a lubricant.

The magnetic material powder is not particularly limited, provided that it is a powder of a known magnetic material used in powder magnetic cores. Examples thereof include, for instance, powders comprising particles of a Fe-based ferromagnetic metal. Examples of Fe-based ferromagnetic metals include, for instance, Fe, Fe—Al—Si (sendust) systems, Fe—Ni (permalloy) systems, Fe—Co systems, Fe—Si systems, Fe—Si—Cr systems, Fe—P systems, Fe—Mo—Ni (supermalloy) or the like. The foregoing can be used singly or in combinations of two or more. The above-described magnetic material powder according to the present invention may contain unavoidable impurities.

The composition ratios of the various elements in the magnetic material are not particularly limited, provided that the object of the present invention can be achieved. When the magnetic material is, for instance, a Fe—Si—Cr ferromagnetic metal, the composition may be 1 to 7 wt % Si, 1 to 5 wt % Cr, and the balance Fe. When the magnetic material is, for instance, a Fe—Ni ferromagnetic metal, the composition may be 40 to 85 wt % Ni and the balance Fe.

In terms of enhancing magnetic permeability and reducing magnetic core loss, the average particle size of the ferromagnetic metal powder is preferably of 3 to 150 μm, more preferably of 5 to 80 μm. The method for manufacturing the ferromagnetic metal powder is not particularly limited, and may be appropriately selected from among atomizing methods such as water atomization, gas atomization or the like, rapid solidification using a cooling base, or reduction. In water atomization, high-pressure water is injected into a molten raw-material alloy flowing out of a nozzle, to cool the alloy solidifying it into powder. Powderization is preferably carried out in a non-oxidizing atmosphere, to prevent oxidation of the powder.

The binder resin is an insulating resin for binding the above magnetic material powder. The surface of the magnetic material powder is coated partially or entirely by the binder resin. The binder resin is appropriately selected in accordance with the required characteristics of the magnetic core. Examples of the binder resin include, for instance, various organic polymeric resins, silicone resins, phenolic resins, epoxy resins as well as liquid glass. Preferred amongst such binder resins are epoxy resins, on account of their excellent solvent resistance. Such binder resins can be used singly or in combinations of two or more. The above materials may be used combined with inorganic materials such as molding auxiliary agents or the like.

The addition amount of binder resin added varies depending on the required characteristics of the magnetic core. For instance, the binder resin may be added in an amount of 0.5 to 10 wt % relative to the total mass of the powder magnetic core 1. An addition amount of binder resin in excess of 10 wt % tends to lower magnetic permeability and to increase magnetic core loss. On the other hand, an addition amount of binder resin below 1 wt % makes insulating properties more difficult to preserve. A more preferred addition amount of binder resin ranges from 1.0 to 5.0 wt % relative to the total mass of the powder magnetic core 1.

A lubricant may be added in an amount ranging from about 0.1 to about 1 wt % relative to the total mass of the powder magnetic core 1, preferably in an amount of 0.2 to 0.8 wt % relative to the weight of the powder magnetic core 1. More preferably, the addition amount of lubricant is 0.3 to 0.8 wt %. An addition amount of lubricant below 0.1 wt % is likelier to result in molding cracks. An addition amount of lubricant in excess of 1 wt % favors a decrease in molding density and magnetic permeability. As the lubricant there may be used, for instance, aluminum stearate, barium stearate, magnesium stearate, calcium stearate, zinc stearate, strontium stearate or the like, singly or in combinations of two or more. Amongst these, aluminum stearate is preferably used as the lubricant on account of its low spring-back.

A cross-linking agent may be added to the magnetic material powder. Adding a cross-linking agent allows increasing the mechanical strength of the powder magnetic core 1 without impairing the magnetic characteristics thereof. The addition amount of cross-linking agent ranges preferably from 10 to 40 parts by weight relative to 100 parts by weight of binder resin. An organic titanium-based cross-linking agent can be used as the cross-linking agent.

In the powder magnetic core 1, the apparent density D thereof, the abundance E of the magnetic material powder in the surface of the powder magnetic core 1, the mass ratio Rm of the magnetic material powder relative to the powder magnetic core 1, and the true density Dm of the magnetic material powder satisfy the condition represented by expression (1) above. More specifically, when the magnetic material powder in the powder magnetic core 1 is, for instance, a Fe—Ni or Fe—Si—Cr ferromagnetic metal powder, and the binder resin is an epoxy resin, the apparent density D of the powder magnetic core 1 and the abundance E of the magnetic material powder in the surface of the powder magnetic core 1 preferably satisfy the condition represented by expression (2) above, more preferably expression (2a) above.

When the magnetic material powder in the powder magnetic core is a Fe—Si—Cr ferromagnetic metal powder and the binder resin is an epoxy resin, the apparent density D of the powder magnetic core 1 and the abundance E of the magnetic material powder in the surface of the powder magnetic core 1 preferably satisfy the condition represented by expression (3) above, more preferably expression (3a) above. When the magnetic material powder in the powder magnetic core is a Fe—Ni ferromagnetic metal powder and the binder resin is an epoxy resin, the apparent density D of the powder magnetic core 1 and the abundance E of the magnetic material powder in the surface of the powder magnetic core 1 preferably satisfy the condition represented by expression (4) above, more preferably expression (4a) above.

Surface abrasion is suppressed to a greater extent in the powder magnetic core 1 of the present embodiment, satisfying the above-described conditions, than is the case in a conventional powder magnetic core. This allows, as a result, sufficiently preventing electric conductance at the outer wall faces 112a, b side wall faces 113a,b and the side faces of the joining portion 12 which correspond to the side faces of the powder magnetic core 1. The dielectric withstand voltage properties between the top faces 104 and 114a,b in the core portion 10 and the pot portion 11 and the main face 124b of the joining portion 12, in the powder magnetic core 1, become therefore enhanced vis-à-vis conventional dielectric withstand voltage properties. In the powder magnetic core as a whole, however, there is virtually no change in the distance between magnetic material powder portions, and hence it becomes possible to maintain a similar magnetic permeability compared with the case of surface abrasion.

A detailed explanation follows next on an example of a method for manufacturing the powder magnetic core 1 according to the present embodiment. The method for manufacturing the powder magnetic core 1 comprises a magnetic material powder preparation step of preparing the above magnetic material powder; a resin coating step of coating a binder resin onto the magnetic material powder; a molding step of molding the resulting mixture; and a heating treatment step of heating the molded product obtained in the molding step. Firstly, the above-described magnetic material powder is prepared in the magnetic material powder preparation step. The magnetic material powder may be a commercially available product, or may be synthesized in accordance with a known method.

In the subsequent resin coating step, predefined amounts of magnetic material powder and binder resin are mixed first. If a cross-linking agent is used, the cross-linking agent is mixed with the magnetic material powder and the binder resin. A pressing kneader or the like is used for mixing, which is carried out preferably at room temperature for 20 to 60 minutes. The obtained mixture is preferably dried at about 100 to 300° C., over 20 to 60 minutes. The dried mixture is then crushed, to yield a mixture comprising the magnetic material powder, the binder resin coated with the magnetic material powder, and the cross-linking agent. Part of the binder resin may be cross-linked by the cross-linking agent. If needed, a lubricant is added next to the mixture. After addition of the lubricant, the mixture is preferably further mixed for 10 to 40 minutes.

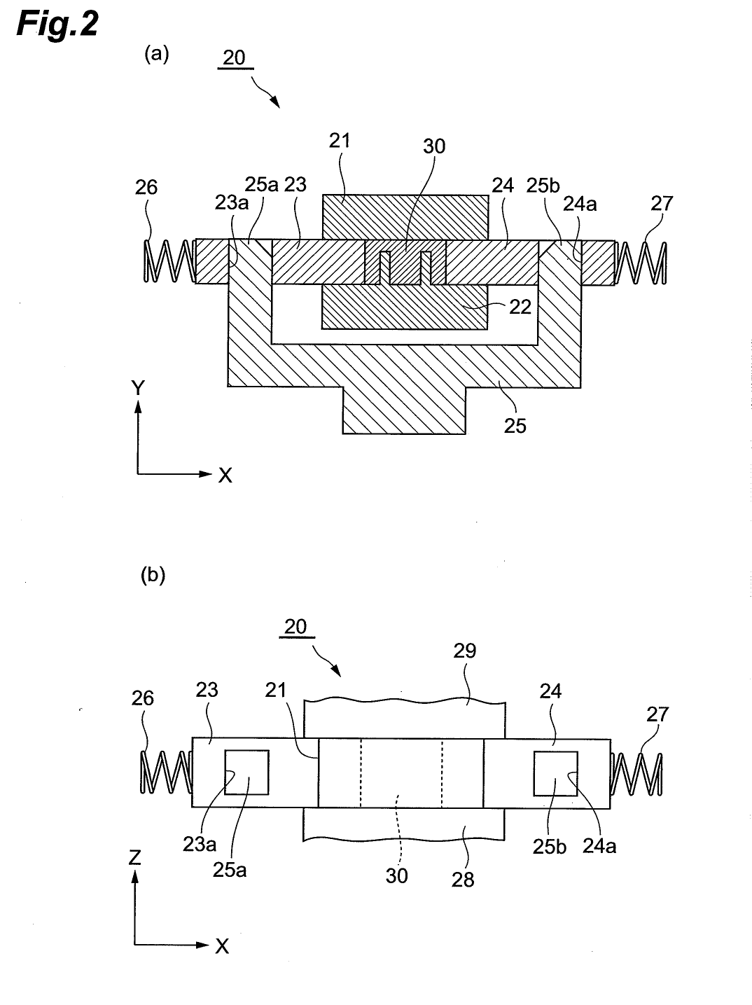

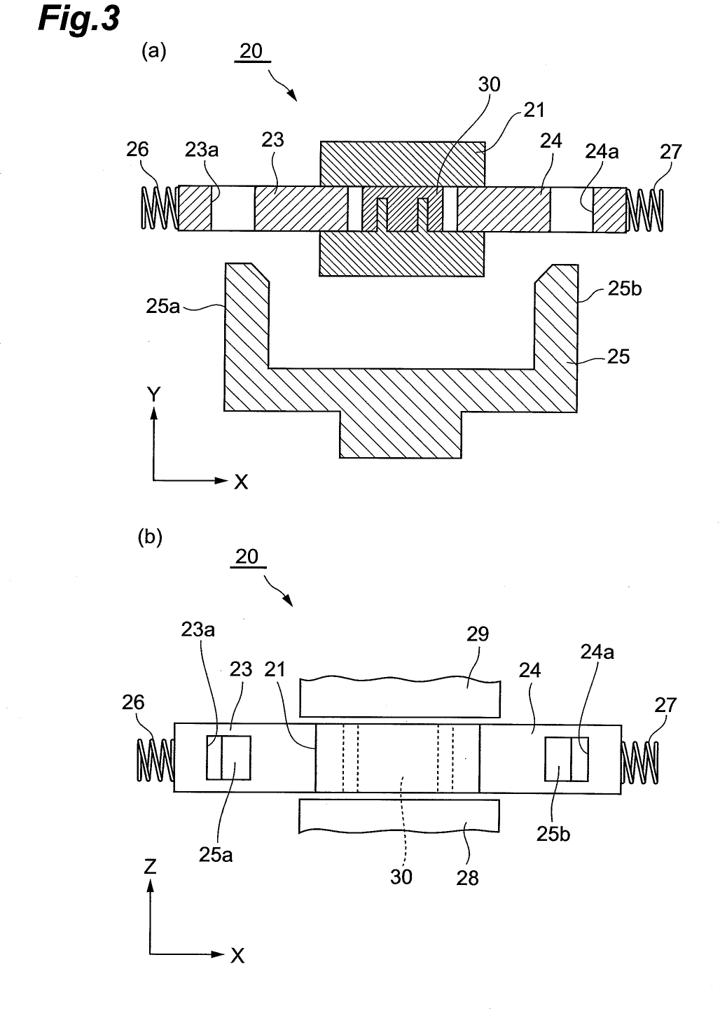

In the subsequent molding step, a molded product is obtained by molding the above mixture with the lubricant added therein. FIGS. 2 and 3 are diagrams illustrating schematically the operation of a molding device preferably used during the molding step. (a) of FIGS. 2 and 3 show a cross-sectional diagram and (b) of FIGS. 2 and 3 show a plan-view diagram of (a) of FIGS. 2 and 3 viewed from above. A molding device 20 comprises an upper punch 21 and a lower punch 22 opposite each other in the Y-axis direction; a pair of dies 23, 24 mutually opposite in the X-axis direction and flanked partially by the upper punch 21 and the lower punch 22; a pair of springs 26, 27 for exerting an elastic force in the direction along which the pair of dies 23, 24 separate from each other, a key-like portion 25 for bringing the pair of dies 23, 24 close together, and a pair of dies 28, 29 mutually opposite in the Z-axis direction. The mold for molding the molded product is thus delimited by the mutually opposing faces of the upper punch 21 and the lower punch 22, the mutually opposing faces of the pair of dies 23, 24, and the mutually opposing faces of the pair of dies 28, 29.

The upper punch 21 and the lower punch 22 can move independently from each other at least in the Y-axis direction, while the upper punch 21 is wholly removable. The face of the upper punch 21 opposite the lower punch 22 is planar in shape. The surface shape of the lower punch 22 on the side facing the upper punch 21 is at least identical to the shape formed by the outer peripheral face 101 and the top face 104 of the core portion 10, the inner wall faces 111a,b and top faces 114a,b of the pot portion 11, and the main face 124a of the joining portion 12 of the powder magnetic core 1.

The pair of dies 23, 24 can at least move independently from each other in the X-axis direction. The mutually opposing faces of the pair of dies 23,24 are planar in shape. The pair of dies 23, 24 comprises through-holes 23a, 24a running through the dies in the Y-axis direction. The pair of springs 26, 27 are joined to the dies 23, 24. The key-like portion 25 comprises protrusions 25a,b that are insertable into the through-holes 23a, 24a of the dies 23, 24. The through-holes 23a, 24a and the protrusions 25a,b have a rectangular shape in the XZ cross section. The dies 23, 24 become fixed through insertion of the protrusions 25a,b into the through-holes 23a, 24a.

Similarly, the pair of dies 28, 29 can move independently from each other at least in the Z-axis direction. The mutually opposing faces of the pair of dies 28, 29 are planar in shape. Similar to the above dies 23, 24, displacement and fixing of the dies 28, 29 are carried out by way of through-holes, springs, key-like portion and protrusions (not shown) provided in the dies 28, 29.

To set up the molding device 20 in the molding step, firstly the dies 23, 24 are fixed by inserting the protrusions 25a,b of the key-like portion 25 into the through-holes 23a, 24a of the dies 23, 24. The dies 28, 29 are fixed in a similar way. The lower punch 22 is fixed by being brought into contact with the dies 23, 24, with the upper punch 21 removed. A space is formed thereby enclosed by the lower punch 22, the dies 23, 24, and the dies 28, 29. A predefined amount of the above mixture is then filled into that space. The upper punch 21 and lower punch 22 are arranged next facing each other, and then compression is exerted in the direction along which the upper punch 21 and the lower punch 22 come close to each other. The mixture is compression-molded as a result, to yield a molded product 30. FIG. 2 illustrates compression molding of the mixture. The molded product 30 has substantially the same shape as the powder magnetic core 1.

The molding conditions are not particularly limited, and may be appropriately decided in accordance with, for instance, the shape and dimensions of the magnetic material powder, and the dimensions and required density of the powder magnetic core. Maximum pressure ranges ordinarily, for instance, from about 100 to about 1000 MPa, preferably from about 200 to about 800 MPa, with the duration over which maximum pressure is held ranging from about 0.1 second to about 1 minute. An excessively low molding pressure is likely to preclude achieving sufficient characteristics and mechanical strength.

The molded product 30 is removed next from the molding device 20. To that end, firstly compression between the upper punch 21 and the lower punch 22 is discontinued. Next the protrusions 25a,b of the key-like portion 25 are pulled out through the through-holes 23a, 24a of the dies 23, 24. As a result, the dies 23, 24 move away from each other through the elastic force of the springs 26, 27. Similarly, the dies 28, 29 move away from each other. Lastly, the molded product 30 can be taken out by removing the upper punch 21 (see FIG. 3).

In the subsequent heating treatment step, the molded product 30 obtained as described above is held at a temperature of, for instance, 150 to 300° C. for 15 to 45 minutes. The binder resin comprised as an insulating material in the molded product 30 becomes cured thereby, yielding the powder magnetic core 1.

In the present embodiment, the molded product 30 is removed from the molding device 20 as described above. As a result, abrasion is sufficiently prevented between the mold of the molding device 20 and the top face 104 of the core portion 10, the outer wall faces 112a,b and side wall faces 113a,b of the pot portion 11, as well as the side faces and main face 124b of the ion source 12, of the powder magnetic core 1. Thus, the binder resin remains in the surface of the powder magnetic core 1, without peeling therefrom, and/or spread of magnetic material powder is sufficiently prevented on the surface of the powder magnetic core 1. The powder magnetic core 1 satisfies expression (1), and, depending on the type of magnetic material powder and binder resin, satisfies expressions (2), (2a), (3), (3a), (4) and (4a). As a result, the powder magnetic core 1 can preserve high magnetic permeability, while the dielectric withstand voltage properties of the powder magnetic core 1 can be dramatically enhanced vis-à-vis conventional ones.

The present invention is not limited to the above-described preferred embodiment. Various modifications thereof are possible without departing from the scope of the invention.

In another embodiment of the invention, for instance, the molding device may not be limited to the above molding device 20, provided that abrasion between the surface of the powder magnetic core 1 and the mold can be suppressed more than in conventional technologies. Similarly, the method for removing the molded product from the molding device is not particularly limited, provided that abrasion between the surface of the powder magnetic core 1 and the mold is more suppressed more than in conventional technologies.

Obviously, in the above expression (1), the mass ratio Rm of the magnetic material powder relative to the powder magnetic core 1, the true density Dm of the magnetic material powder, and also the coefficient a and the threshold value Vc vary depending on, for instance, the type and composition ratio of the materials in the magnetic material powder. The coefficient a and the threshold value Vc are determined experimentally.

More specifically, first there are decided the various materials, and there is fixed a composition ratio thereof, in the magnetic material powder, binder resin and the like. Plural powder magnetic cores are manufactured then in accordance with a known method involving abrasion between mold and molded product. However, only molding pressure is changed during manufacture of the molded product. Next there are derived the obtained apparent density D of the powder magnetic core and the abundance E of the magnetic material powder in the predefined surface. A graph is plotted then with values corresponding to the 2/3 power of the apparent density D of the powder magnetic core represented on the X-axis, and the abundance E of the magnetic material powder represented on the Y-axis. The abundance ratio Rm and the true density Dm of the magnetic material powder are known, and hence the coefficient a can be determined by approximating the plot to a linear function by least squares. The threshold value Vc may be the minimum value at which the above plot overlaps with the linear function straight line in the state where inclination of the linear function straight line is fixed. Alternatively, the threshold value Vc may be a value obtained by deriving the measurement error from the standard deviation, and subtracting then the measurement error from the above linear function straight line.

In another embodiment, the powder magnetic core satisfies preferably the condition represented by expression (1a) below

Vc≧E−a×(D·Rm/Dm)^{2/3}×100 (1a)

(in expression (1a), Vc, E, a, D, Rm and Dm are the same as in expression (1)).

In this case, the coefficient a and the threshold value Vc are derived as follows. Firstly there are decided the various materials, and there is fixed a composition ratio thereof, for the magnetic material powder, binder resin and the like. Plural powder magnetic cores are manufactured then in accordance with the above method that curbs abrasion between mold and molded product. However, only molding pressure is changed during manufacture of the molded product. Next there are derived the obtained apparent density D of the powder magnetic core and the abundance E of the magnetic material powder in the predefined surface. A graph is plotted then with values corresponding to the 2/3 power of the apparent density D of the powder magnetic core represented on the X-axis and the abundance E of the magnetic material powder represented on the Y-axis. The ratio Rm and the true density Dm of the magnetic material powder are known, and hence the coefficient a can be determined by approximating the plot to a linear function by least squares. The threshold value Vc may be the maximum value at which the above plot overlaps with the linear function straight line in the state where inclination of the linear function straight line is fixed. Alternatively, the threshold value Vc may be a value obtained by deriving the measurement error from the standard deviation, and adding then the measurement error to the above linear function straight line.

### EXAMPLES

The present invention is explained in more detail next based on examples. The invention is in no way meant to be limited, however, to or by these examples.

### Examples 1 to 6

Firstly there were prepared a Fe—Si—Cr magnetic material powder and a Fe—Ni magnetic material powder. The Fe—Si—Cr magnetic material powder was Fe 93.5 wt %, Si 5.0 wt %, and Cr 1.5 wt %, and had an average particle size of 15 μm. The Fe—Ni magnetic material powder was Fe 50 wt % and Ni 50 wt %, and had an average particle size of 25 μm. The average particle size was the numerical value measured using a laser diffraction particle size analyzer (HELOS system, by JEOL).

To the above magnetic material powders there was added 3 wt % of a epoxy resin (N695, by Maruzen Sekiyu Co., Ltd.) as the binder resin, relative to total amount. The whole was then mixed for 30 minutes at room temperature in a pressured kneader. After drying, aluminum stearate (SA-1000 by Sakai Chemical Industry), as a lubricant, was added to the magnetic material powders in an amount of 0.3 wt % relative to total weight, with mixing for 15 minutes in a V-mixer.

Molded products were then obtained by molding the mixtures in a molding device identical to the above-described molding device 20. The apparent density D of the eventually obtained powder magnetic cores, as well as the abundance E of the magnetic material powder on the surface of the powder magnetic cores were made to vary by modifying the molding pressure. Three molding pressures 600 MPa, 750 MPa and 900 MPa were applied. The epoxy resin as the binder resin was cured by heating the molded product, after compression, at 180° C. for 30 minutes, to yield three types each of Fe—Si—Cr and Fe—Ni powder magnetic cores. The dimensions of the powder magnetic cores were: height 2.5 mm, distance between the outer wall faces and the side wall faces of the pot portion 6.5 mm, and short diameter of the elliptical cylinder of the core portion 2.0 mm.

The powder magnetic cores of Examples 1, 2, 3 correspond to Fe—Si—Cr cores in ascending order of molding pressure, while those of Examples 4, 5, 6 correspond to Fe—Ni powder magnetic cores in ascending order of molding pressure.

### Comparative Examples 1-6

Compressed-powder magnetic cores in Comparative examples 1 to 6 were obtained in the same way as in Examples 1 to 6 but using herein a conventional molding device instead of a molding device identical to the above-described molding device 20. In the molding device, moreover, there was used a mold in which although the upper and lower punches were movable, all other portions were fixed. Molding pressure was such so as to obtain the same apparent density D as in the examples. The obtained molded products were removed by pushing up the lower punch. The side faces of the molded products exhibited overall peeling of binder resin and/or spread of magnetic material powder caused by abrasion with the mold. The dimensions of the powder magnetic cores were: height 2.5 mm, distance between the outer wall faces and the side wall faces of the pot portion 6.0 mm, and short diameter of the elliptical cylinder of the core portion 2.0 mm.

The powder magnetic cores of Comparative examples 1, 2, 3 correspond to Fe—Si—Cr cores in ascending order of molding pressure, while those of Comparative examples 4, 5, 6 correspond to Fe—Ni powder magnetic cores in ascending order of molding pressure.

Measurement of Apparent Density D

The mass of the obtained powder magnetic cores was measured. Also, the apparent volume of the powder magnetic cores was measured by an Archimedean method. The apparent density D of the powder magnetic cores was derived from the mass and the apparent volume. The results are given in Table 1.

Measurement of the Abundance E

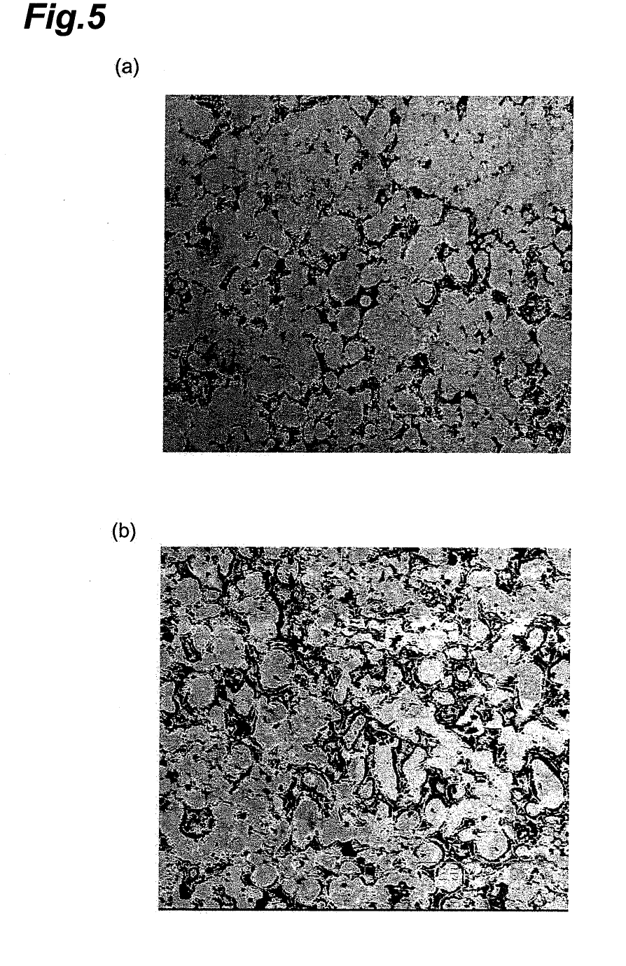

A predefined surface (300 μm×300 μm rectangular surface portion, corresponding to the outer wall faces 112a,b of the pot portion 11 in the powder magnetic core 1) of the obtained powder magnetic cores was imaged by SEM to yield SEM photographs. Examples of the obtained SEM photographs are depicted in (a) and (b) of FIG. 5. (a) of FIG. 5 is a SEM photograph of the powder magnetic core of Comparative example 1, while (b) of FIG. 5 is a SEM photograph of the powder magnetic core of Example 1. The dark portions in the photographs denote the magnetic material powder. The abundance E of the magnetic material powder was derived based on image analysis of the SEM photographs. The results are given in Table 1.

TABLE 1

| | | | | | Dielectric |
|---|---|---|---|---|---|
| | | | | Magnetic | withstand |
| | | Apparent | Abun- | permea- | voltage |
| | Magnetic | density D | dance | bility | properties |
| | material | g/cm³ | E % | (μi/μO) | (V) |
| Example 1 | Fe—Si—Cr | 5.67 | 70 | 24 | 240 |
| Example 2 | | 5.90 | 75 | 28 | 220 |
| Example 3 | | 6.05 | 75 | 30 | 200 |
| Example 4 | Fe—Ni | 6.83 | 76 | 32 | 160 |
| Example 5 | | 6.98 | 78 | 35 | 110 |
| Example 6 | | 7.08 | 79 | 42 | 80 |
| Comparative | Fe—Si—Cr | 5.67 | 80 | 24 | 120 |
| example 1 | | | | | |
| Comparative | | 5.90 | 89 | 28 | 100 |
| example 2 | | | | | |
| Comparative | | 6.05 | 90 | 30 | 70 |
| example 3 | | | | | |
| Comparative | Fe—Ni | 6.83 | 87 | 32 | 40 |
| example 4 | | | | | |
| Comparative | | 6.98 | 88 | 35 | 40 |
| example 5 | | | | | |
| Comparative | | 7.08 | 93 | 42 | 30 |
| example 6 | | | | | |

Measurement of Magnetic Permeability

Magnetic permeability of the obtained powder magnetic cores was measured at 0.3 MHz in accordance with a known method. The results are given in Table 1.

Evaluation of Dielectric Withstand Voltage Properties

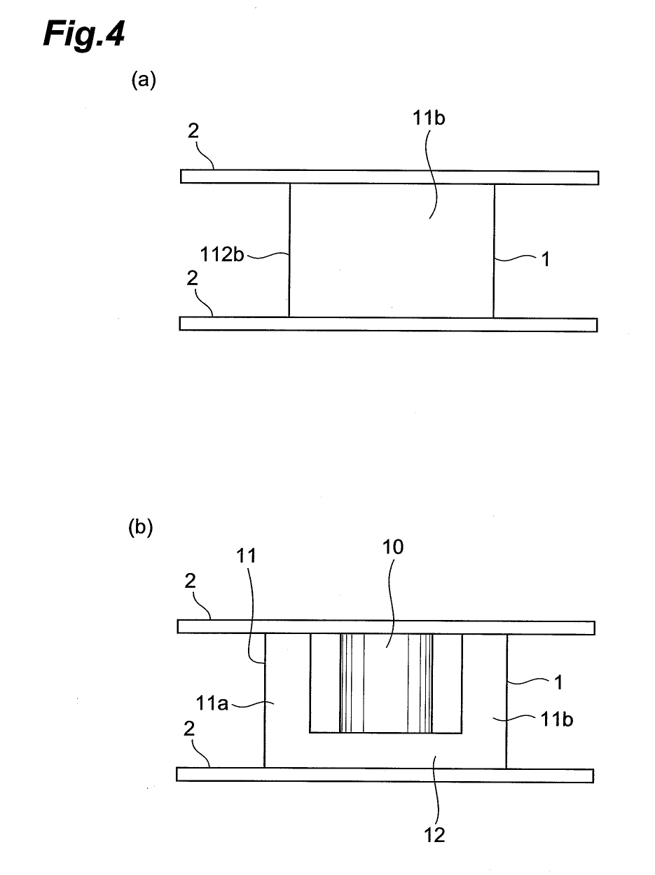

The obtained powder magnetic cores 1 were sandwiched between square copper electrodes 2 for measurement, as illustrated in FIG. 4. (a) of FIG. 4 is a front view diagram viewed from the outer wall face 112b of the pot portion 11b, while (b) of FIG. 4 is a front view diagram viewed from the side wall faces 113a,b of the pot portion 11. Voltage was applied gradually between the square copper plate electrodes 2. To evaluate dielectric withstand voltage properties, the voltage was measured when the current flowing between the square copper plate electrodes 2 reached 0.5 mA. The results are given in Table 1. The powder magnetic cores exhibit better dielectric withstand voltage properties as the voltage value becomes higher.

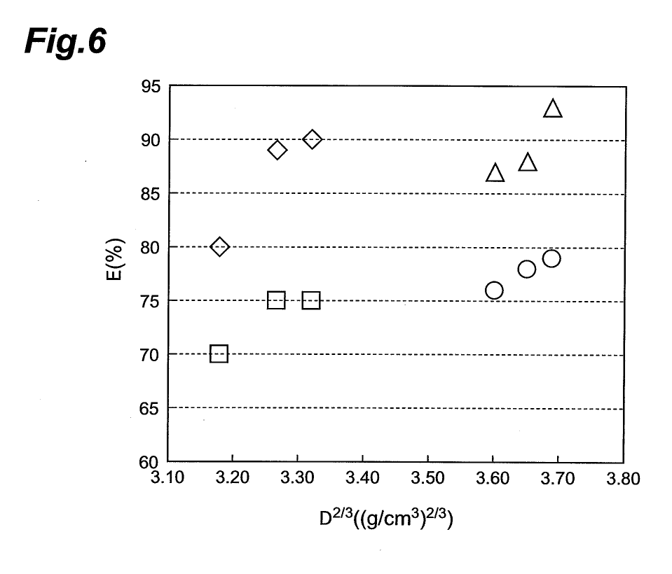

FIG. 6 illustrates a graph obtained by plotting values corresponding to the 2/3 power of the apparent density D of the obtained powder magnetic cores versus the abundance E of the magnetic material powder. In the figure, the “□” plot represents the results for Fe—Si—Cr powder magnetic cores according to the examples, the “O” plot represents the results for Fe—Ni powder magnetic cores according to the examples, the “⋄” plot represents the results for Fe—Si—Cr powder magnetic cores according to the comparative examples, and the “Δ” plot represents the results for Fe—Ni powder magnetic cores according to the comparative examples. The conditions represented by expressions (2), (2a), (3) and (3a) are derived from FIG. 6 taking measurement error into account.

What is claimed is:

1. A powder magnetic core containing a magnetic material powder and a binder resin,
wherein the apparent density D of said powder magnetic core, the abundance E of said magnetic material powder in a surface of said powder magnetic core, the mass ratio Rm of said magnetic material powder relative to said powder magnetic core, and the true density Dm of said magnetic material powder satisfy the condition represented by expression (1)
Vc>E−a×(D·Rm/Dm)^{2/3}×100 (1)
(in expression (1) the units of D and Dm are g/cm³, the unit of E is %, and Rm is unitless. Vc denotes a predefined threshold value, and a denotes a predefined coefficient).

2. A powder magnetic core containing a magnetic material powder and a binder resin,
wherein the apparent density D of said powder magnetic core and the abundance E of said magnetic material powder in a surface of said powder magnetic core satisfy the condition represented by expression (2)
39>E−12.5×(D^{2/3}) (2)
(in expression (2), the unit of D is g/cm³ and the unit of E is %).

3. The powder magnetic core according to claim 2, wherein the apparent density D of said powder magnetic core and the abundance E of said magnetic material powder in the surface of said powder magnetic core satisfy the condition represented by expression (2a)
35≧E−12.5×(D^{2/3}) (2a)
(in expression (2a), the unit of D is g/cm³ and the unit of E is %).

4. The powder magnetic core according to claim 2, wherein said magnetic material powder is a Fe—Si—Cr magnetic material powder,
and wherein the apparent density D of said powder magnetic core and the abundance E of said magnetic material powder in the surface of said powder magnetic core satisfy the condition represented by expression (3)
−40>E−37.4×(D^{2/3}) (3)
(in expression (3), the unit of D is g/cm³ and the unit of E is %).

5. The powder magnetic core according to claim 4, wherein the apparent density D of said powder magnetic core and the abundance E of said magnetic material powder in the surface of said powder magnetic core satisfy the condition represented by expression (3a).
−46≧E−37.4×(D^{2/3}) (3a)
(in expression (3a), the unit of D is g/cm³ and the unit of E is %).

6. The powder magnetic core according to claim 2, wherein said magnetic material powder is a Fe—Ni magnetic material powder,
and wherein the apparent density D of said powder magnetic core and the abundance E of said magnetic material powder in the surface of said powder magnetic core satisfy the condition represented by expression (4).
−39>E−34.4×(D^{2/3}) (4)
(in expression (4), the unit of D is g/cm³ and the unit of E is %).

7. The powder magnetic core according to claim 4, wherein the apparent density D of said powder magnetic core and the abundance E of said magnetic material powder in the surface of said powder magnetic core satisfy the condition represented by expression (4a).
−47≧E−34.4×(D^{2/3}) (4a)
(in expression (4a), the unit of D is g/cm³ and the unit of E is %).
